(19) United States
(12) Patent Application Publication
(10) Pub. No.: US 2008/0043230 A1
(43) Pub. Date: Feb. 21, 2008

(54) Method for spatially high-resolution imaging

(76) Inventors: Gerhard Krampert, Jena (DE); Thomas Heinlein, Jena (DE)

Correspondence Address: JACOBSON HOLMAN PLLC, 400 SEVENTH STREET N.W., SUITE 600, WASHINGTON, DC, 20004, US

(21) Appl. No.: 11/806,476

(22) Filed: May 31, 2007

(30) Foreign Application Priority Data
May 31, 2006 (DE) 10 2006 026 203.4

(51) Int. Cl. G01J 3/46

(52) U.S. Cl. 356/311

(57) ABSTRACT

Method for spatially high-resolution imaging a structure of a sample marked with a substance comprising selecting the substance from substances that are capable of being repeatedly switched from a first state with first optical characteristics to a second state with second optical characteristics and which can revert from the second state to the first state; switching the selected substance in areas of the sample via a changeover signal from the first state to the second state; intentionally omitting a defined area during switching; recording an optical measurement signal to be allocated to the substance in the first state for a recording area that comprises the intentionally omitted area in addition to areas in which the substance is switched to the second state; and selecting the substance from substances in which both of the states differ from each other by a predetermined criteria and the substance is a synthesized nanoparticle.

### BACKGROUND OF THE INVENTION

(1) Field of the Invention

The present invention relates to a method for spatially high-resolution imaging of a structure marked with a substance of a sample. The substance is selected from a group of substances that are capable of being repeatedly switched with an optical changeover signal from a first state with first optical characteristics to a second state with second optical characteristics and which are capable of reverting from the second state to the first state.

(2) Description of Related Art

The spatial resolution of optical imaging methods is in principle fixed by the diffraction limit (Abbe limit) in the wavelength of the relevant optical signal. However, there are already known methods in the field of fluorescent microscopy, in which the diffraction limit in the imaging of a structure of a sample is effectively undershot through exploitation of nonlinear correlations between the acuity of the effective focal spot and the beamed-in intensity of an optical stimulation signal.

Examples are the multiphoton absorption in the sample or the generation of higher harmonics of the optical excitation signal. The saturation of an optically induced transfer can also be used as a nonlinear correlation, for example, in a stimulated emission depletion (STED) of the fluorescing state or a ground state depletion (GSD). With both of these methods, which in principle can achieve molecular resolutions, a fluorescent dye, with which the structure of interest of a sample is marked everywhere that an optical changeover signal exceeds a characteristic threshold, designated in this description as saturation threshold, is shifted to an energy state at which fluorescence (no longer) occurs. If the spatial area from which a measurement signal is still being recorded is established via a local intensity minimum of the optical changeover signal that has a zero point and is generated, for example, by interference, the dimensions of the area and thus the achieved spatial resolution are smaller than the diffraction limit. The reason for this is that the spatial, limited partial area from which the measurement signal is recorded is narrowed by the increasing degree of saturation of the depletion of the state in which the fluorescence is generated. In the same manner, the edge of a focal spot or strip will become steeper, which also leads to an increased spatial resolution.

For falling below the resolution limit postulated by Abbe, a nonlinear interaction between the illumination light and the fluorophors of the sample is employed in various optical imaging methods. In stimulated emission depletion (STED) (See for example U.S. Pat. No. 5,731,588) microscopy, the nonlinear process employed is the saturation of the excitation by stimulated emission. In contrast, the saturation of excitation generally known to the prior art is used in saturated patterned excitation microscopy (SPEM) (See for example EP 1,157,279) to maintain a nonlinearity in the response of the fluorophor.

For the achievement of an object image (image of an object structure), the basic idea is to record at least two partial images of an object. In each case under different illumination intensities, spatial patterns are formed on the object, wherein for an object point, there is in each case, a nonlinear dependence of the light detected from the object point of the illumination intensities given on the object point. The partial images contain various contributions of different spatial frequency fractions of the object structure, in order to achieve the desired object image from the partial images by reconstruction of the spatial frequency fractions. The setting of illumination intensities with different spatial patterns for capturing the various partial images has the advantage that lower and higher frequency spatial frequency fractions are virtually generated in the pattern of the illumination intensities. In this way, the spatial frequency fractions of the object structure are linked. Through this linkage, the spatial frequency fractions of the object structure are displaced relative to the spatial frequency interval, which is open for an image capture as a function of the light optical transfer function (OTF). The complete object image with an appropriately expanded spatial frequency area can be reconstructed from the partial images.

In the STED method, a sample or a fluorescent dye in the sample is excited to fluorescence via an optical stimulation signal. The spatial area of the excitation to which the diffraction limit applies is then reduced, wherein a minimum intensity of an interference pattern of a de-excitation light radiation as a changeover signal is superimposed thereon. Everywhere that the changeover signal exceeds a saturation threshold, the fluorescent dye is completely deactivated by stimulated emission, i.e., de-excited from the previous excited energy state. The remaining spatial area from which fluorescence is still spontaneously being emitted corresponds only to a reduced area around the zero point of the intensity minimum, in which the changeover signal was either not present or not present with sufficient intensity. Although this method of fluorescence microscopy reproducibly delivers a spatial resolution below the diffraction limit, there are also associated disadvantages. For example, the life span of the energized state of the fluorescent dye that is excited by the excitation radiation is only brief.

In order for the changeover to be completed effectively within an even shorter time period, a comparatively high intensity of the changeover signal must be used. In order to achieve a nonlinear correlation between the residual fluorescence and the intensity of the changeover signal with the de-excitation by said changeover signal, in other words, to achieve saturation, the intensity of the de-excitation radiation must additionally be very high. In general, a pulsed high performance laser, that makes the implementation of the known method quite expensive, is required for the de-excitation light radiation.

These same disadvantages also apply to known ground state depletion (GSD) methods (See for example, S. W. Hell and M. Kroug, Appl. Phys. B 60 (1995) 495). In GSD methods, time restrictions and performance requirements are set by the short life spans of the energized states involved. The peak performance requirements, however, are less than with STED. EP 1616216 A3 describes the switching with fluorescing proteins and its application in increasing the resolution in a fluorescence microscope.

The nonlinear interaction entails some problems, which are common to these and all related methods for increasing resolution. The previously employed dyes are generally suitable for generating a sufficient nonlinear response only under certain conditions. For example, many dyes show intensified bleaching under conditions of high-resolution methods (Dyba et al., Appl. Opt. 42 (25), pp. 5123-5129, 2003). To stabilize, for example, the dye Cy5 under nonlinear response conditions, additives such as triplet quenchers and oxygen catchers must be added to it (Heilemann et al., J. Am. Chem. Soc. 127, pp. 3801-3806, 2005). These additives, however, severely limit utility, as they are not compatible with, for example, the necessary physiological environment for in vivo experiments. Furthermore, many interesting dyes that have important properties for high resolution cannot be used under these physiological conditions, for example, with water as the solvent (Irie et al., Nature 420 (6917), pp. 759-760, 2002). The reasons for this lie, among other things, in the fact that they show either very little solubility in water, which is a highly polar solvent, or that they show a decreasing quantum yield with increasing polarity of the solvent (Liang et al., Proc. Natl. Acad. Sci. USA 100 (14), pp. 8109-8112, 2003).

Some methods for increasing resolution, such as ground state depletion (GSD), which are very attractive due to their easy implementation and required setup, cannot be used because of the lack of stability of the dyes with regard to the required type of nonlinear interaction. An object of the present invention is to increase the stability.

### BRIEF SUMMARY OF THE INVENTION

The present invention covers a method for the spatially high-resolution imaging of a structure of a sample marked with a substance. The method starts out with selecting the substance from a group of substances that are capable of being repeatedly switched with an optical changeover signal from a first state with first optical characteristics to a second state with second optical characteristics and which are capable of reverting from the second state to the first state. Switching of the substance in areas of the sample takes place by way of a changeover signal to the second state, wherein a defined area is intentionally omitted, and recording of an optical measurement signal to be allocated to the substance in the first state for a recording area that comprises the intentionally omitted area in addition to areas in which the substance is switched to the second state. The substance is selected from a subgroup of substances in which both of the states differ with regard to at least one of the following criteria: conformation state of a molecule; structural formula of a molecule; spatial array of atoms within a molecule; spatial array of bonds within a molecule; attachment of other atoms or molecules to a molecule; grouping of atoms and/or molecules; spatial orientation of a molecule; orientation of neighboring molecules to each other; and an arrangement formed from a plurality of molecules and/or atoms. Of importance is that the substance resides in a synthesized nanoparticle.

After marking the structures with the fluorescent substance, the new imaging method can be implemented with a standard fluorescence microscope, wherein the additional effort for improving the resolution below the diffraction limit is comparatively minor and wherein additional means can be limited to those necessary to generate the optical changeover signal. Examples of such means can comprise a simple laser or also a conventional lamp. In a preferred embodiment, in which measurements are performed simultaneously in a plurality of areas in order to accelerate the method, the measurement signals are read out of the individual areas simultaneously with a (CCD) camera. The complete image of the sample is then achieved by the joining of several images with different positions of areas measured in the sample.

### BRIEF DESCRIPTION OF THE DRAWINGS

The invention is better understood by reading the following Detailed Description of the Preferred Embodiments with reference to the accompanying drawing figures, in which like reference numerals refer to like elements throughout, and in which:

FIG. 1 shows a nanoparticle employed in accordance with the invention, comprising a silicon oxide core with embedded fluorophors, e.g., Cy5, a silicon oxide shell, and a functional coating with, say, antibodies.

FIG. 2 shows the switching action (image from PSF engineering) with nanoparticles containing, e.g., Cy5 as a photo-switch.

FIG. 3 shows the unstructured intensity distribution for fluorescence stimulation and deactivation of the nanoparticles and the sinusoidal-modulated intensity distribution for activation of the nanoparticles.

FIG. 4 shows the energy diagram of a nanoparticle FRET construct with a donor dye and six acceptor dye molecules in a nanoparticle.

### DETAILED DESCRIPTION OF THE PREFERRED EMBODIMENTS

In describing preferred embodiments of the present invention illustrated in the drawings, specific terminology is employed for the sake of clarity. However, the invention is not intended to be limited to the specific terminology so selected, and it is to be understood that each specific element includes all technical equivalents that operate in a similar manner to accomplish a similar purpose.

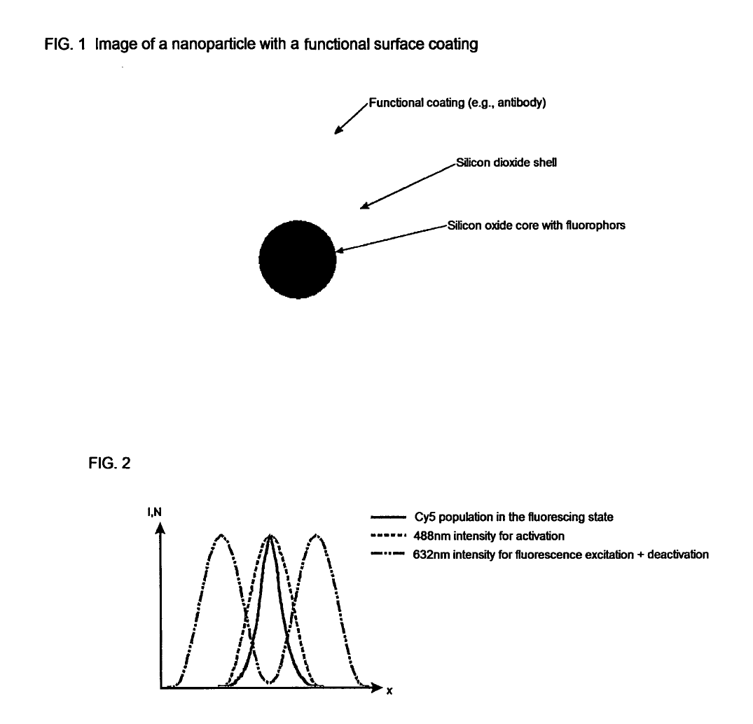

FIG. 1 shows a nanoparticle employed in accordance with the invention, comprising a silicon oxide core with embedded fluorophors, e.g., Cy5, a silicon oxide shell, and a functional coating with, say, antibodies.

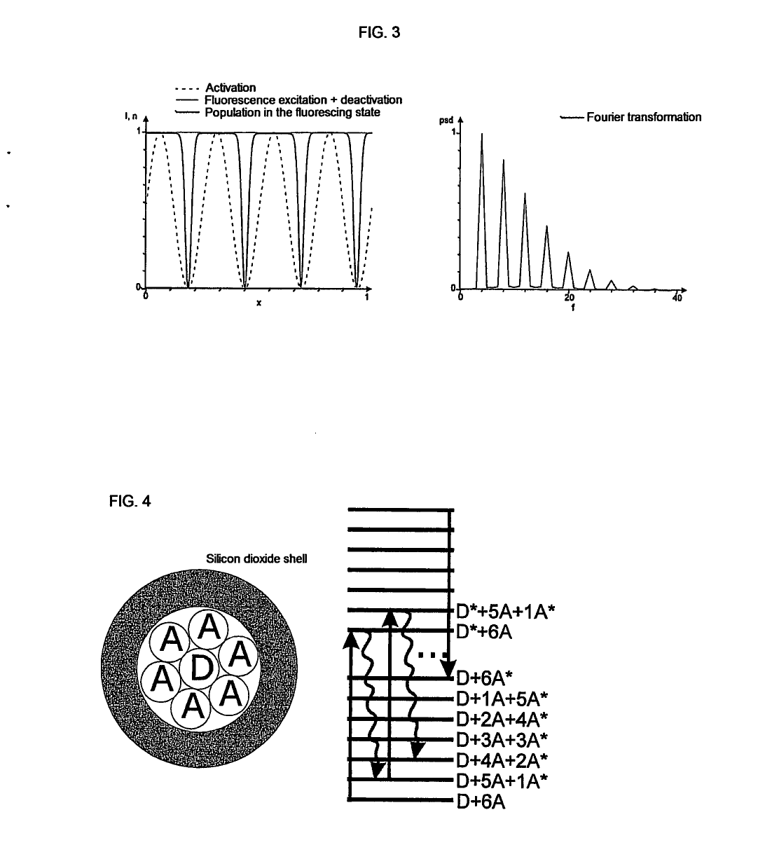

FIG. 2 shows the switching action (image from PSF engineering) with nanoparticles containing, e.g., Cy5 as a photo-switch. FIG. 2 shows the diffraction-limited intensity distributions for activation (e.g., 488 nm for Cy5) or for fluorescence stimulation and simultaneous deactivation (e.g., 632 nm). Through the nonlinear correlation between the intensities and the switching state of the nanoparticles, a distribution of fluorescing nanoparticles that are clearly smaller than the diffraction limit can be achieved. The nonlinear correlation for the calculation of FIG. 2 is determined from the switching rates (on and off) by solving the rate equations. FIG. 3 shows the image of the excitation distribution with structured illumination and the resultant harmonics of the illumination through the nonlinear response of the dye.

FIG. 3 shows the unstructured intensity distribution for fluorescence stimulation and deactivation of the nanoparticles and the sinusoidal-modulated intensity distribution for activation of the nanoparticles. Through the nonlinear correlation between the intensities and the switching state of the nanoparticles, not only the spatial frequency of the sinusoidal modulation, but also the harmonics thereof, is transferred to the sample (discernible in the Fourier transformation of the spatial distribution of the fluorescing nanoparticles). By capturing a plurality of images with spatially displaced sinusoidal patterns, a single, high-resolution image can be generated in Fourier space from these individual images by means of an analysis algorithm. The nonlinear correlation was calculated as in FIG. 2.

FIG. 4 shows the energy diagram of a nanoparticle FRET construct with a donor dye and six acceptor dye molecules in a nanoparticle. D and D* are the ground and the first excited states of the donor molecule, respectively. Analogously, the ground and the first excited state of an acceptor molecule are designated with A and A*. The number in front of A or A* gives the number of the acceptor molecules that are in the respective state A or A*. The straight arrows stand for a transfer involving a photon, i.e., absorption or emission of a photon, whereas the arrows with wavy lines stand for the radiation-less energy transfer from the donor molecule to an acceptor molecule. When the donor molecule is excited, fluorescent light will only be emitted (yellow arrow) in the event that all of the acceptor molecules are already excited.

To stabilize dyes under nonlinear response conditions, a series of methods using core-shell particles is proposed. These nanoparticles can be synthesized based on, for example, silicon oxide. This synthesis, among others, is disclosed in US 2004/0101822 A1. In this synthesis, one or a plurality of dye molecules is enclosed in a silicon dioxide shell, whereby the interactions of these chromophors with other substances in the sample are capable of being systematically altered, for example, minimized. Also, the interactions with substances that are additionally included in the nuclear interior of the nanoparticle in the synthesis are capable of being systematically varied in their intensity or concentration. Chemical and physical effects of the chromophors and additives on the interior of the nanoparticle can be restricted by the chemically inert silicon dioxide shell and consequently the effects on the outer environment of the sample can be minimized. A series of inventive methods, which shall be described in the following, is derived from this fundamental principle.

In order to exert a positive effect on the bleaching characteristics of dyes under nonlinear response conditions, one or a plurality of substances from the following classes (e—donors, triplet quenchers, oxygen quenchers, etc.) can be packed in the interior of the particle in addition to the fluorophors. The nanoparticle shell ensures that no significant quantities of these substances will penetrate outside in the sample and alter the environmental conditions. The same holds true in reverse for substances in the sample, e.g., water that could have a negative effect on the properties of the dyes.

The presence of the substances in the immediate proximity of the dye molecules can inhibit or severely restrict the efficacy of a plurality of bleaching channels, such as excited state absorption with subsequent formation of a non-luminescent dye cation. The particular advantage in silicon dioxide nanoparticles lies in the low quantity of additives required due to their spatial proximity to the dye molecules and the low to vanishing effect of the additives on the sample to be examined.

The addition of some components can occur at various points in time. The composition of the dots and the nature of the bond can also be varied. It is important for said components to be in contact with the dyes, either through covalent bonding to the dyes or to molecules in their proximity, i.e., in the core or on the interior side of the shell. Alternatively, it would be conceivable to attach the additives non-covalently so that they are capable of dispersing within the core without, however, being capable of diffusion through the shell of the dot to the outside. An example of an addition of APTS is described in US 2004/0101822 at paragraph 0143 and identified as Example 1.

Furthermore, the shell of the particle can be used to isolate deleterious substances or environmental characteristics such as oxygen, solvents, pH, etc. of the sample to be examined from the fluorophor(s) and reduce adverse interactions. This enables the creation of a microenvironment for the respective dye that is ideally adapted to the requirements of the dye without having to sacrifice the macro-environment with its physiological or other desirable properties. The shell of the nanoparticles enables in particular the use of dyes in solvent environments in which they were not measurable or else very difficult to measure. Quantum yields and bleaching resistance in particular can be substantially improved by these methods. There is an especially great potential in the field of photoswitchable fluorophors, which are almost exclusively insoluble in water and therefore usable only to a very limited extent.

In addition to this expanded area of utility, such nanoparticles offer a much greater potential for the optimization of photoswitchable molecules. A possibility would be the manufacture of an “artificial rhodopsin system,” i.e., the improvement of the switching characteristics of the chromophor by embedding in an outer shell. The chromophor of the rhodopsin protein, retinal, thus shows considerably poorer switching characteristics, for example, a considerably slower switching speed and lower quantum efficiency of the switching, in solution than in its natural protein surrounding. By the interaction of the chromophor with the outer shell, it is thus possible to intervene systematically in the quantum mechanical dynamics of photoswitchable molecules and thus improve their characteristics. In very general terms, a new possibility for systematically altering or optimizing the characteristics of dyes is achieved through the embedding in an outer shell.

In addition to these improvements to the dyes, the compatibility of the sample with regard to specific dyes can also be increased. For example, dyes that previously could only be used in fixed cell samples due to their toxicity to biological samples can be artificially reduced in their toxicity by embedding in a shell and thus also be employed in living cells. The effects of dyeing on the function of the object to be examined can thus be reduced.

Furthermore, a functionalization can be achieved by an additional coating of the particle surfaces with molecules, wherein preference is given to molecules from the following classes: chemical modification (wherein preference is given to alcohols, amines, organic acids, halogenides, thiols and their derivatives), nucleotides, peptides, proteins (in particular antibodies and antigens), chromophors (in particular fluorophors).

Furthermore, nanoparticles, by embedding several dyes with overlapping absorption and emission spectra, make it possible to synthesize FRET (Forster resonance energy transfer) constructs, which are of particular interest for high-resolution imaging due to their strongly nonlinear response to excitation light. The intensity of the interaction between the donor dye and the acceptor dye molecules can be varied systematically (e.g., by distance, solvent, etc.).

The use of substances having two states with different optical characteristics is a central aspect of the invention. Such a substance can be systematically switched with one changeover signal from the first state to the second state. This process is reversible. In other words, the substance is also capable of being switched back to the first state or reverting thereto on its own. The optical characteristics of the substance in the first state differ from those in the second state in that only they support the measurement signal. However, it is not mandatory for the relevant optical characteristics to be “binary,” i.e., that they are present 100% in one of the states and 0% in the other state. Rather, it is sufficient if the differences in the relevant optical characteristics are great enough to enable an at least predominant allocation of the measurement signal to the first state.

In fact both of the states differ with regard to at least one of the following criteria: conformation state of a molecule; structural formula of a molecule; spatial array of atoms within a molecule; spatial array of bonds within a molecule; attachment of other atoms or molecules to a molecule; grouping of atoms and/or molecules; spatial orientation of a molecule; orientation of neighboring molecules to each other; and arrangement formed from a plurality of molecules and/or atoms. To switch the corresponding substances from their first state to their second state, the optical changeover signal effects, e.g., a rearrangement of atom groups, a photoisomerization, in particular a cis-trans isomerization, a photocyclization, a protonization or deprotonizations, a spin flip, an electron transfer and/or energy transfer between bonded molecules or molecular units.

An advantage of the invention with regard to the prior art in the field of fluorescence microscopy lies in that the states of the substances under consideration generally have exponentially longer life spans than the energy states involved in the fluorescence. The life span of the second state is therefore generally at least 1 ns. Preference is given to a life span of at least 10 ns. Special preference is given to thermally stable states. Numerous changeover processes, in which the initial and/or the final state is relatively long-lived (>10 ns), can be activated and saturated with comparatively low intensities and brought to saturation. This is because there are only proportionately slow or sometimes even no processes competing with the changeover process.

The different optical characteristics of both of the states of the substance can be different spectral characteristics. For example, the first optical characteristics can have different absorptions for an optical test signal with regard to the second optical characteristics, wherein the measurement signal can be observed in transmission or also in reflection. Preference is given to different luminescences from groups comprising fluorescence, phosphorescence, electroluminescence, and chemoluminescence as different spectral characteristics.

Molecules that change their spectral characteristics, in particular their color, and which are also suitable as substances for marking the structure of interest in the scope of the invention are also designated as photochroms. In lieu of different spectral characteristics, both of the states of the substance can also have different polarization characteristics, e.g., with regard to an optical test signal or a measurement signal emitted by the sample.

In order to fall below the diffraction limit with the new method in the spatial resolution, the substance and the changeover signal must be adjusted to each other so that the switching via the changeover signal from the first state to the second state is nonlinearly dependent on the intensity of said changeover signal. This is achieved when the switching of the substance to the second state is completed or essentially completed everywhere that the changeover signal exceeds a saturation threshold. To be precise, the intensity of the changeover signal must exceed the saturation threshold in the entire recording area with the exception of the intentionally omitted spatial area, and the intentionally omitted spatial area must simultaneously be a minimum local intensity of the changeover signal. Such a local intensity minimum with a zero point of the intensity can be achieved with an interference pattern. In principle, projections can also be employed to this end; moreover, the changeover signal can be beamed in laterally at an acute or obtuse angle. Furthermore, holograms can be used to generate local intensity minima of the changeover signal. With the intensity minima of simple interference patterns, however, it is especially easy to define the smallest spatial areas omitted by the changeover signal.

With the new methods, preference is given to the use of substances that are capable of being transferred via another switching signal from the second state to the first state. Like the changeover signal, the other switching signal can also be an optical signal. However, it can also be, e.g., an electrical or a thermal signal. Furthermore, a spontaneous, i.e., thermally driven, even at ambient temperature, switching back to the first state is possible. It is known that molecules undergoing a photoinduced cis-trans isomerization can revert to the first state by thermal means alone. With the other switching signal, however, the substance can be systematically switched back to the first state, which can be advantageous in terms of accelerating the method overall.

Preference is given to use of the other switching signal prior to the changeover signal or after the measurement signal is recorded. As long as the changeover with the changeover signal is not substantially negatively impacted by the other switching signal, the other switching signal can still be applied to the sample during the application of the changeover signal. Furthermore, it is not mandatory to limit the other switching signal to the spatial area of interest, which thus reduces the effort required to apply optical switching signals as well as enables the use of other kinds of other switching signals.

If a test signal is directed to the sample in order to generate the measurement signal to be recorded, the test signal is applied to the sample after the changeover signal. The test signal can therefore also be applied to the sample over a larger area comprising the intentionally omitted spatial area. The spatial delimitation required for increasing the spatial resolution of the new method is provided by the optical changeover signal.

If light emitted from the sample is used as the measurement signal, an appropriate excitation signal, which is used as a test signal, can also be applied to the sample simultaneously with the changeover signal. In any case, however, the excitation signal should be applied to the sample later than, or at the earliest simultaneously with the other switching signal, given that the excitation signal and the other switching signal are not identical anyway.

In order to generate a complete image of a sample, it is necessary to raster, i.e., scan at all points, the sample with the area intentionally omitted by the changeover signal. In doing so, the sample can also be measured simultaneously in several points separated from each other, i.e., defined areas, at a given point in time. In doing so, several optical measurement signals, which must be allocated to the substance in the first state, are recorded simultaneously but separately from each other, for several recording areas that, along with areas in which the substance is switched to the second state, always comprise an intentionally omitted area. The rastering can always be achieved by a spatial displacement of the employed switching signal, in particular the changeover signal, relative to the coordinates of the sample. As preference is given to all of the spatial areas intentionally omitted by the changeover signal being intensity minima of an interference pattern, the rastering can be achieved by the displacement of one or a plurality of interference minima of the changeover signal. The displacement can be achieved by a simple phase displacement of the interfering beams.

In the rastering of a sample according to the new method, there is a cyclical sequence of steps: Switching of the substance in areas of the sample to a second state via the changeover signal, wherein a defined area is intentionally omitted; recording of the optical measurement signal, which must be allocated to the substance in the first state, for a recording area always comprising an intentionally omitted area; and switching of the substance to the first state. As already indicated, to this end it is sufficient if only the changeover signal with its intensity minimum is always precisely directed to the defined area of interest of the sample.

After marking the structures with the fluorescent substance, the new imaging method can be implemented with a standard fluorescence microscope, wherein the additional effort for improving the resolution below the diffraction limit is comparatively minor and wherein additional means can be limited to those necessary to generate the optical changeover signal. Examples of such means can comprise a simple laser or also a conventional lamp. In a preferred embodiment, in which measurements are performed simultaneously in a plurality of areas in order to accelerate the method, the measurement signals are read out of the individual areas simultaneously with a (CCD) camera. The complete image of the sample is then achieved by the joining of several images with different positions of areas measured in the sample.

Modifications and variations of the above-described embodiments of the present invention are possible, as appreciated by those skilled in the art in light of the above teachings. It is therefore to be understood that, within the scope of the appended claims and their equivalents, the invention may be practiced otherwise than as specifically described.

1. A method for the spatially high-resolution imaging of a structure of a sample marked with a substance, comprising the steps:
selecting the substance from a group of substances that are capable of being repeatedly switched with an optical changeover signal from a first state with first optical characteristics to a second state with second optical characteristics and which are capable of reverting from the second state to the first state;
switching the selected substance in areas of the sample via a changeover signal from the first state to the second state;
intentionally omitting a defined area during the switching;
recording an optical measurement signal to be allocated to the substance in the first state for a recording area that comprises the intentionally omitted area in addition to areas in which the substance is switched to the second state; and
selecting the substance from a subgroup of substances in which both of the states differ from each other by a predetermined criteria and the substance resides in a synthesized nanoparticle.

2. The method as in claim 1, wherein the nanoparticle has a shell that is suitable for attachment to other substances.

3. The method as in claim 2, wherein said shell is coated with molecules.

4. The method as in claim 1, wherein said shell is hydrophobic or hydrophilic.

5. The method as in claim 1, wherein said shell is optically transparent.

6. The method as in claim 1, wherein said shell is composed of silicon.

7. The method of claim 1, wherein said nanoparticle is a silicon-containing compound.

8. The method as in claim 1, wherein the substances are chemically synthesized, organic or inorganic dyes.

9. The method as in claim 1, further comprising the steps of: inserting additives in said nanoparticle for influencing the dye behavior in said nanoparticle.

10. The method as in claim 1, further comprising the steps of: inserting additives such as electron donors, triplet quenchers, oxygen quenchers, or other chromophor-stabilizing substances in said nanoparticle.

11. The method as in claim 1, wherein the life span of the second state is longer than 1 ns.

12. The method as in claim 1, wherein the different optical characteristics of both of the states of the substance are different spectral characteristics.

13. The method as in claim 1, wherein the first optical characteristics with regard to the second optical characteristics have different absorptions of a test signal.

14. The method as in claim 1, wherein the first optical characteristics with regard to the second optical characteristics have different luminescences from the group consisting of fluorescence, phosphorescence, electroluminescence, and chemoluminescence.

15. The method as in claim 1, wherein the substance and the changeover signal are adjusted to each other in such a way that everywhere that the intensity of said changeover signal exceeds a saturation threshold, the second state of the substance is completely adjusted.

16. The method as in claim 15, wherein the intensity of the changeover signal in the entire recording area outside of the intentionally omitted area exceeds the saturation threshold and that the intentionally omitted spatial area is a local intensity minimum of the changeover signal.

17. The method as in claim 16, wherein the local intensity minimum of the changeover signal is an intensity minimum with a zero point of an interference pattern.

18. The method as in claim 1, wherein the substance is selected from the group of substances that are capable of being switched from the second state to the first state via a second switching signal.

19. The method as in claim 18, wherein the second switching signal is applied to the sample prior to or simultaneously with the changeover signal.

20. The method as in claim 18, wherein the second switching signal is applied to the sample over a larger area comprising the recording area.

21. The method as in claim 1, wherein a test signal is applied to the sample after the changeover signal.

22. The method as in claim 21, wherein said test signal is applied to the sample over a larger area comprising the intentionally omitted area.

23. The method as in claim 1, wherein the different optical characteristics of the states of the substance are different polarization characteristics.
